(19) United States
(12) Patent Application Publication
(10) Pub. No.: US 2005/0135842 A1
(43) Pub. Date: Jun. 23, 2005

(54) Developer supply container

(75) Inventors: Katsuya Murakami, Toride-shi (JP); Yutaka Ban, Tokyo (JP); Nobuo Nakajima, Kashiwa-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/004,975

(22) Filed: Dec. 7, 2004

(30) Foreign Application Priority Data
Dec. 10, 2003 (JP) 411339/2003(PAT.)
Nov. 26, 2004 (JP) 341604/2004(PAT.)

(51) Int. Cl. G03G 15/08

(52) U.S. Cl. 399/262

(57) ABSTRACT

A developer supply container detachably mountable to developer receiving apparatus, includes container body accommodating a developer, the container body being provided with a developer supply port for supplying the developer through a developer receiving port provided in the developer receiving apparatus; a driving connecting member for operatively collectable with a driving member provided in the developer receiving apparatus, the driving connecting member being movable relative to the container body; an interrelating mechanism for interrelating an operation of movement of the driving connecting member to operatively couple with the driving member with an operation of movement of the developer supply port to face the developer receiving port.

### FIELD OF THE INVENTION AND RELATED ART

The present invention relates to a developer supply container for supplying such an image forming apparatus as a copying machine, a facsimileing machine, a printer, etc., which employs an electrophotographic or electrostatic recording method, with developer.

As the developer for an image forming apparatus such as an electrophotographic copying machine, a printer, etc., particulate toner has long been used. Thus, it has been a common practice to supply the image forming apparatus with developer with the use of a developer supply container, as the developer in the main assembly of an image forming apparatus is depleted by consumption. However, this method has been problematic in that during the operation for supplying an image forming apparatus with developer, the developer scatters, contaminating an operator and/or the adjacencies of the apparatus, because developer is in the form of extremely minute particulates. Thus, various methods for supplying an image forming apparatus with developer have been developed, and some of them have been put to practical use. According to one of such methods, a developer supply container is placed in the main assembly of an image forming apparatus, and developer is discharged from the developer supply container little by little through the small opening with which the developer supply container is provided.

Regarding a developer supply containers, such as the above described one in accordance with the prior art, a substantial number of proposals have been made to place in a developer supply container, a member for conveying developer while stirring it. For example, according to Japanese Laid-open Patent Application 7-199620 or Japanese Patent No. 3095050 (which corresponds to U.S. Pat. No. 5,572,301), the cylindrical wall of the cylindrical container is provided with a developer outlet, in the form of a slit, which extends in the axial direction of the cylindrical container. When the cylindrical developer container is mounted into the main assembly of an image forming apparatus, it is to be positioned so that the developer outlet faces upward. Then, after the container is completely mounted, the container is to be rotated so that the developer outlet of the developer container aligns with the developer inlet on the image forming apparatus side.

On the other hand, there have also been proposed a substantial number of developer supplying methods different from the above described ones. According to them, after the mounting of the developer supply container into the main assembly of an image forming apparatus, the developer outlet of the developer supply container is opened or closed while the container proper of the developer supply container is kept immobilized. For example, according to the developer supplying method disclosed in Japanese Laid-open Patent Application 11-194600(which corresponds to U.S. Pat. No. 6,185,401), the cylindrical developer supply container is mounted into the main assembly of an image forming apparatus, and then, the handle of the container is rotated to open the shutter of the container.

Each of the abovementioned developer supply containers is structured so that roughly at the end of the process of mounting the developer supply container into the main assembly of an image forming apparatus, the coupler on the developer supply container side automatically couples with the driving force transmission mechanism on the main assembly side of the image forming apparatus. Thus, even if an operator forgets to unseal the developer supply container, the coupler on the developer supply container side is enabled to receive rotational driving force from the driving force transmitting mechanism on the main assembly side. Therefore, it is possible that the developer in the developer supply container will be damaged. Thus, in order to deal with this kind of problem, the main assembly of an image forming apparatus is provided with an error prevention mechanism which detects whether or not a developer supply container has been unsealed, and prevents a developer supply container from being driven when the container has not been unsealed. However, should this mechanism breaks down for some reason, the occurrence of the above described problem cannot be avoided. Obviously, it is possible to take various measures to prevent the error prevention mechanism from breaking down or malfunctioning. However, such measures are problematic in that they tend to make an image forming apparatus complicated, and also, add to the apparatus cost.

Japanese Laid-open Patent Application 2003-162137 proposes a structural arrangement for dealing with the above described problems. According to this application, the coupler on the developer supply container side does not automatically couple with the driving force transmission mechanism on the main assembly side of an image forming apparatus toward the end of the process of mounting the developer supply container into the main assembly. More specifically, the developer supply container is provided with a lever which is to be rotated to cause the coupler on the container side to project in the direction parallel to the thrust direction thereof, and the lever is to be rotated after the mounting of the container into the main assembly to make the coupler on the container side couple with the driving force transmission mechanism on the main assembly side.

However, it is possible that even the developer supply container disclosed in Japanese Laid-open Patent Application 2000-162137 will suffer from the above described problem, because of the following reason. That is, in the case of the developer supply container disclosed in this patent application, the operation for unsealing the developer supply container is independent from the operation for causing the coupler of the container to project to make the coupler to couple with the driving mechanism on the main assembly side. Therefore, there is the possibility that even though the developer supply container has not been unsealed, the operation for coupling the coupler on the container side with the driving mechanism on the main assembly side will be carried out, causing thereby the above described problem.

Further, in the case of the developer supply container disclosed in Japanese Laid-open Patent Application 2003-162137, the operation for unsealing the developer supply container, and the operation for connecting the developer supply container with the driving mechanism, are independent from each other, turning the operation for replenishing an image forming apparatus with developer into an annoyance. In other words, the developer supply container disclosed in this patent application also falls short in operability.

### SUMMARY OF THE INVENTION

The primary object of the present invention is to provide a developer supply container superior, in operability, to developer supply containers in accordance with the prior art.

Another object of the present invention is to provide a developer supply container which does not damage the developer therein.

These and other objects, features, and advantages of the present invention will become more apparent upon consideration of the following description of the preferred embodiments of the present invention, taken in conjunction with the accompanying drawings.

### BRIEF DESCRIPTION OF THE DRAWINGS

FIG. 1 is a sectional view of the image forming apparatus in one of the preferred embodiments of the present invention, showing the general structure thereof.

FIG. 2 is a schematic sectional view of the developing apparatus in the first embodiment of the present invention.

FIGS. 3(a), 3(b), and 3(c) are perspective view, side view, and enlarged top view, of the toner supply container in the first embodiment of the present invention.

FIGS. 4(a) and 4(b) are perspective views of the coupling on the developer supply container side, in the first embodiment of the present invention.

FIGS. 5(a) and 5(b) are perspective views of the intermediary member of the driving force receiving portion on the developer supply container side, in the first embodiment of the present invention.

FIGS. 6(a) and 6(b) are perspective views of the driving force receiving coupling and intermediary member of the developer supply container, showing the states of them before and after, respectively, the coupling supporting portion is moved to engage the coupler on the developer supply container side with the driving force transmitting mechanism on the main assembly side.

FIGS. 7(a) and 7(b) are perspective views of the toner receiving apparatus in the first embodiment of the present invention, showing the state of the apparatus before and after, respectively, the toner receiving hole is unsealed, and FIG. 7(c) is a top view of the toner receiving apparatus.

FIGS. 8(a), 8(b), and 8(c) are perspective view, sectional view (perpendicular to the axial line of the developer supply container), and enlarged top view, respectively, of the toner supply container and toner receiving apparatus, immediately after the mounting of the former into the latter.

FIGS. 9(a), 9(b), and 9(c) are perspective view, sectional view (perpendicular to the axial line of the developer supply container), and enlarged top view, respectively, of the toner supply container and toner receiving apparatus, after the rotation of the handle following the mounting of the toner supply container into the toner receiving apparatus.

FIG. 10 is a perspective view of the toner supply container in the second embodiment of the present invention.

### DETAILED DESCRIPTION OF THE PREFERRED EMBODIMENTS

Next, the developer supply container in the first embodiment of the present invention will be concretely described with reference to the appended drawings.

Embodiment 1

{Image Forming Apparatus}

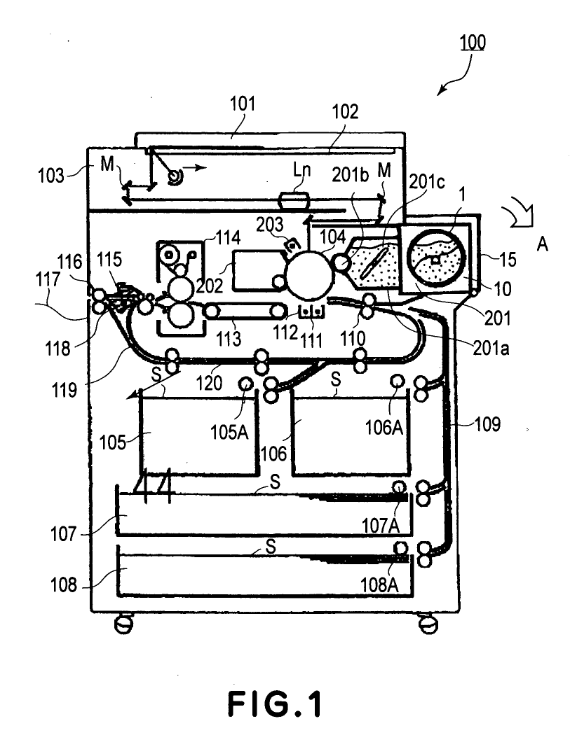

First, referring to FIG. 1, an electrophotographic copying machine, as a typical electrophotographic image forming apparatus, in which a developer supply container in accordance with the present invention is mounted, will be described regarding its structure.

In FIG. 1, designated by a referential number 100 is the main assembly of the electrophotographic copying machine (which hereinafter will be referred to as apparatus main assembly). Designated by a referential number 101 is an original, which is placed on a glass platen 102. An optical image in accordance with the image formation data is formed on the electrophotographic photosensitive drum 104 by the combination of a plurality of mirrors M and a plurality of lenses Ln. Designated by referential numbers 105-108 are cassettes, from among which the cassette containing recording mediums (which hereinafter may be referred to simply as papers) P, which agree in size with the information inputted by an operator through the control panel, or are the most suitable to the size of the original 101, is selected, based on the information regarding the sizes of the papers in the cassettes 105-108. The recording medium does not need to be limited to paper. For example, an OHP sheet or the like may be used as necessary.

The papers P are conveyed one by one by separating and conveying apparatuses 105A-108A, to a pair of registration rollers 110 by way of a paper conveyance path 109. Then, each paper P is conveyed further by the pair of registration rollers 110 in synchronism with the rotation of the photosensitive drum 104 and the scanning timing of the optical portion 103. Designated by referential numbers 111 and 112 are a transfer discharger for transferring the developer image (which hereinafter will be referred to as toner image) formed on the photosensitive drum 104, onto the paper P, and a separation discharger for separating the paper P from the photosensitive drum 104 after the transfer of the toner image onto the paper P, respectively.

Thereafter, the paper P is further conveyed by a paper conveying portion 113 to the fixation station 114, in which the toner image on the paper P is fixed by heat and pressure. Then, when the copying machine is in the single-sided print mode, the paper P is moved through the reversing station 115, without being placed upside down, and is discharged into the delivery tray 117 by a pair of discharge rollers 116. When the machine is in the two-sided print mode, the flapper 118 of the reversing station 115 is controlled so that the paper P is conveyed to the pair of registration rollers 110 by way of re-feeding conveyance paths 119 and 120. Then, the paper P is made to move through the same paths as those through which the paper P is moved when the machine is in the single-sided print mode, and is discharged into the delivery tray 117.

When the machine is in the multilayer print mode, the paper P is sent through the reversing station 115 so that it is stopped after it is partially extended outward from the main assembly by the pair of discharge rollers 116. More specifically, it is stopped immediately after the trailing edge of the paper P is moved past the flapper 118, while the paper P is remaining pinched by the pair of discharge roller 116. Then, the flapper 118 is switched in position, and the pair of discharge rollers 116 are rotated in reverse so that the paper P is conveyed back into the main assembly. Thereafter, the paper P is conveyed to the registration rollers 110 through paper re-conveyance paths 119 and 120. Then, it is moved through the same paths as those through it is moved when the machine is in the single-side print mode, and discharge into the delivery tray 117.

In the main assembly 100 of the copying machine structured as described above, the developing apparatus 201, cleaning station 202, primary charger 203, etc., are disposed in the adjacencies of the peripheral surface of the drum 104. The cleaning station 202 is where the toner remaining on the peripheral surface of the photosensitive drum 104 is removed. The primary charger 302 is for charging the photosensitive drum 104.

{Developing Apparatus}

The developing apparatus 201 is the apparatus which develops, with the use of toner, the electrostatic latent image formed on the peripheral surface of the drum 104 by the optical station 103, based on the image formation data extracted from the original 101. The toner supply container 1 for supplying this developing apparatus 201 with toner is to be removably mounted in the main assembly 100 of the copying machine by a user.

The developing apparatus 201 comprises a toner receiving apparatus 10 as a developer receiving apparatus in which the toner supply container 1 is removably mounted to supply the main assembly of the apparatus with toner, and a developing device 201a (single-component developing device). Further, the developing device 201a comprises a development roller 201b and a developer conveying member 201c.

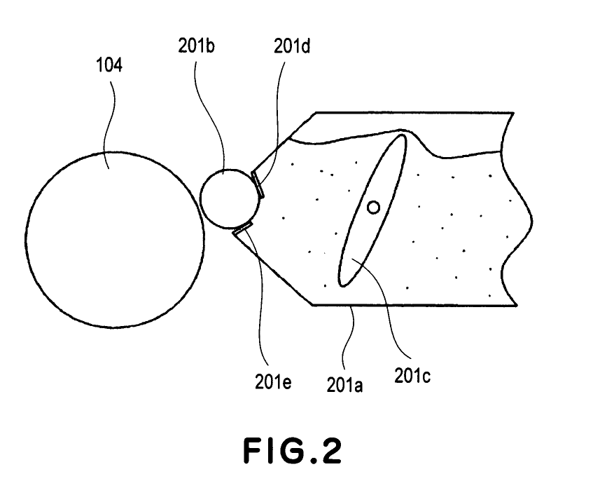

After being supplied from the toner supply container 1 into the toner receiving apparatus 10, the toner is sent by the conveying member 201c to the development roller 201b, by which the toner is supplied to the photosensitive drum 104. Further, referring to FIG. 2, the developing apparatus 201 is provided with a development blade 201d as a regulating member for regulating the amount by which the toner is allowed to remain on the development sleeve 201b, and a toner leak prevention sheet 201e, which is as a member for preventing toner from being blown out of the developing apparatus 201, through the gap between the housing of the developing device 201a and development sleeve 201b, and which is placed in contact with the peripheral surface of the development sleeve 201b.

Incidentally, the developer with which the image forming apparatus in accordance with the present invention is to be supplied may be the toner for a two-component developing device, or mixture of the toner for a two-component developing device and carrier, in addition to the abovementioned toner for a single-component developing device.

The image forming apparatus is provided with a cover 15 for replacing a toner supply container. The cover 15 constitutes a part of the external shell of the apparatus. It is opened in the direction indicated by an arrow mark A in FIG. 1, when a user mounts the toner supply container 1 into the main assembly 100 of the image forming apparatus or removes it therefrom.

{Toner Supply Container}

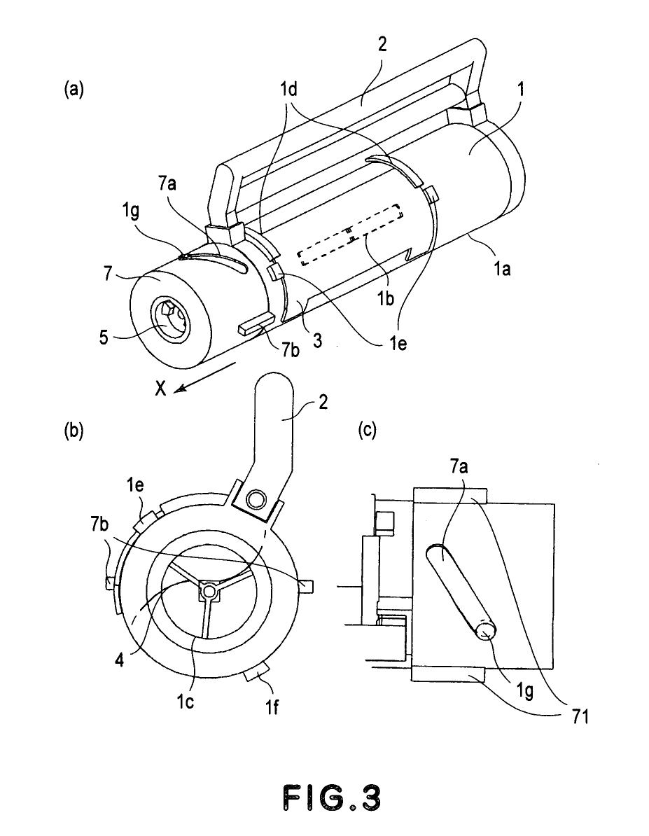

Next, referring to FIGS. 3-5, the toner supply container 1, as a developer supply container, in this embodiment of the present invention will be described regarding its structure.

The toner supply container 1 has a roughly cylindrical container proper 1a, in which toner is stored. The cylindrical wall portion of the container proper 1a is provided with a toner outlet (toner discharge hole) 1b, in the form of a slit, which extends in the lengthwise direction of the container proper 1a.

The container proper 1a is also provided with a toner filling hole 1c, which is a part of one of the end walls of the container proper 1a in terms of the lengthwise direction of the container proper 1a. The toner filling hole 1c is sealed with an unshown sealing member or the like after the container proper 1a is filled with toner.

The toner supply container 1 is provided with a handle 2, which is attached to the cylindrical wall portion of the container proper 1a. This handle 2 is to be grasped when a user mounts or dismount the toner supply container 1, and also, when a user rotates the toner supply container 1.

Further, the toner supply container 1 is provided with a stirring member 4, which is disposed within the container proper 1a. As the stirring member 4 receives rotational driving force through the driving force transmission coupling (which will be described later), it rotates relative to the container proper 1a, conveying thereby the toner in the container proper 1a, while stirring it, and discharge the toner through the toner discharge hole 1b.

Referring to FIG. 3(a), the toner discharge hole 1b is sealed by a container shutter 3, the curvature of which matches that of the cylindrical wall portion of the container proper 1a of the toner supply container 1. The container shutter 3 is engaged with a pair of guiding portions 1d located at the edges of the toner discharge hole 1b, one for one, in terms of the lengthwise direction of the toner supply container 1. The container shutter 3 slidable in the curvature direction of the container proper 1a to open or close the toner discharge hole 1a.

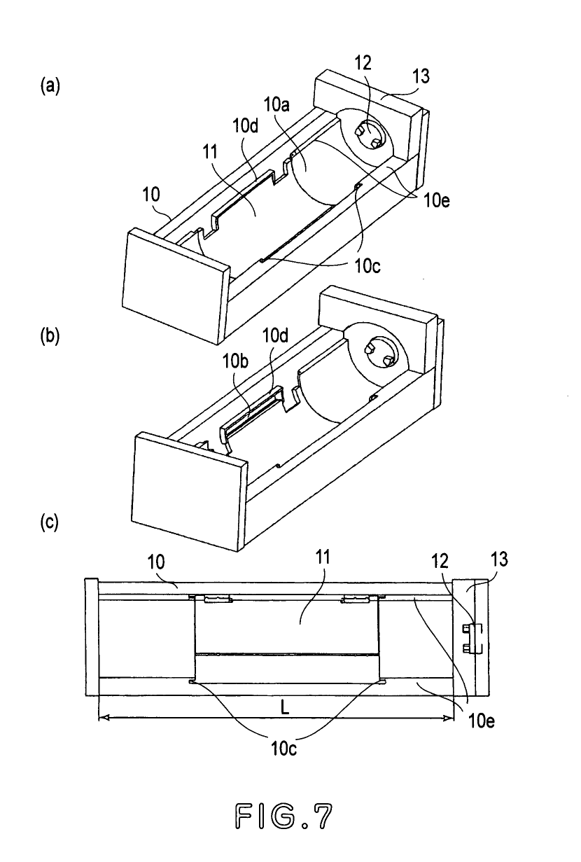

The toner supply container 1 is also provided with a pair of projections 1e, and a pair of projections 1f, which are on the peripheral surface of the container proper 1a. The projections 1e are for pushing down the developing device shutter 11 (which will be described later) to unseal the toner reception hole 10b (FIG. 7) after the toner supply container 1 is set in the toner receiving apparatus 10, whereas the projections 1f are for pulling up the developing device shutter 11 in order to seal the toner reception hole 10b after the toner supplying operation is completed.

The projections 1e for unsealing the tone reception hole 10b, and projections 1f for sealing the toner reception hole 10b, are positioned so that after the mounting of the toner supply container 1 into the toner receiving apparatus 10 (FIG. 7), the projections 1e will be on the upstream and downstream sides, respectively, of the developing device shutter 11, in terms of the direction in which the toner supply container 1 is rotated to unseal the toner reception hole 10b.

Incidentally, the projections 1e and 1f, as shutter engaging portions, do not need to be in the above described form, as long as they are capable of open or close the developing device shutter 11 as the developer supply container 1 is rotated; they may be different in structure.

Further, the toner supply container 1 is provided with a connective means for making the coupling on the toner supply container side couple with the driving force transmitting mechanism of the toner receiving apparatus, as the toner supply container 1 is rotated by an operator by the handle 2 after the mounting of the toner supply container 1 into the toner receiving apparatus, and through which the toner supply container 1 receives the driving force from the main assembly 100. This connective means is structured so that the driving force received by the connective means from the driving force transmitting mechanism is transmitted to the stirring member 4.

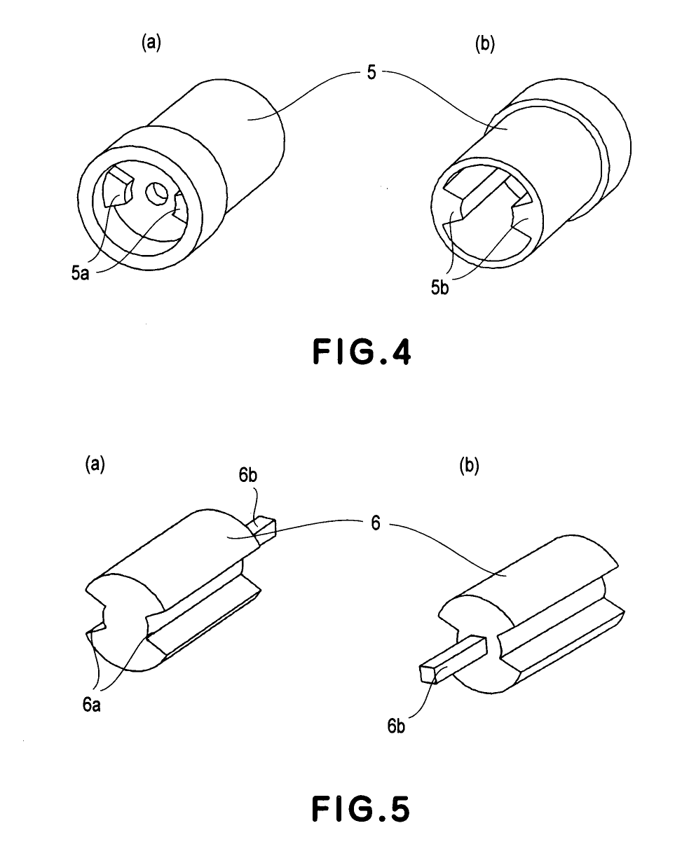

To describe the structure of the connective means, the toner supply container 1 is provided with a coupling 5 as a connective member, which is attached to one of the end walls of the container proper 1a in terms of the lengthwise direction of the container proper 1a. Referring to FIG. 4, this coupling 5 comprises a pair of claw-like portions 5a by which the coupler 5 receives the rotational driving force from the driving force transmitting mechanism of the toner receiving apparatus, and a pair of claw-like portions 5b by which the coupler 5 transmits the received rotational driving force to an intermediary member 6 (FIG. 5).

Referring to FIG. 3, the coupling 5 is supported by a coupling supporting portion 7, which allows the coupling 5 to freely rotate while preventing the coupling 5 from moving in the direction parallel to the axial line of the coupling 5.

Further, the toner supply container 1 is provided with a mechanism (which will be described later) for moving the coupling 5. The coupling moving mechanism is fitted around one end of the container proper 1a. The coupling moving mechanism comprises a camming hole 7a (camming mechanism), which is a part of the coupling, supporting portion 7 and extends at a predetermined angle relative to the lengthwise direction of the container proper 1a, a pair of rotation control projections 7b attached, roughly symmetrically with respect to the axial line of the coupling supporting portion 7, to the peripheral surface of the connective mechanism, a cam follower 1g (camming mechanism) which projects from the peripheral surface of the container proper 1a and is fitted in the camming hole 7a.

As a user rotate the container proper 1a of the toner supply container 1 structured as described above, by grasping the handle 2, the coupling supporting portion 7 is slid with the coupling 5, away from the container proper 1a, by the above described camming mechanism, in the direction (X direction in FIG. 3) parallel to the rotational axis of the container proper 1a. The function of the rotation regulating projections 7b will be described later.

Further, within the container proper 1a, the intermediary member 6 for transmitting the driving force to the stirring member 4 is placed. Referring to FIG. 5, the intermediary member 6 is provided with a groove 6a, the wall of which catches the rotational driving force from the coupling 5, and a shaft portion 6b from which the received rotational driving force is transmitted to the stirring member 4. The intermediary member 6 is supported by the shaft portion 6b so that it does not move in the lengthwise direction of the container proper 1a.

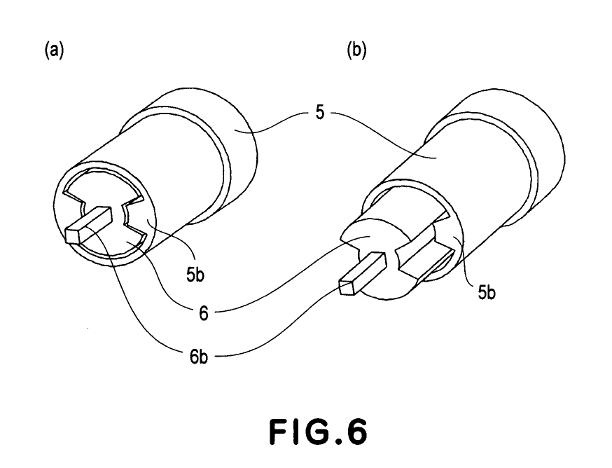

The coupling 5 and intermediary member 6 are engaged with each other, in the toner supply container 1, as shown in FIG. 6(a).

The coupling 5 and coupling supporting portion 7 are structured so that the former is allowed to move back and forth with the latter, in the direction parallel to the axial line of the container proper 1a, and also, that even after the coupling 5 is moved to the location (FIG. 6(b)) at which it engages with the driving mechanism of the toner receiving apparatus, in other words, even after the intermediary member 6 partially comes out of the coupling 5, the driving force can be transmitted to the intermediary member 6.

Next, referring to FIGS. 7(a)-(c), the structure of the toner receiving apparatus 10 in this embodiment will be described.

The toner receiving apparatus 10 is provided with a toner supply container bay 10a in which the toner supply container 1 is removably set, and a toner reception hole 10b through which the toner discharged from the toner supply container 1 is received into the development chamber (unshown). It is also provided with control surfaces 10e, with which the above described rotation control projections 7b of the coupling supporting portion 7 come into contact.

Further, it is provided with a semicylindrical developing device shutter 11, the curvature of which matches the curvatures of the cylindrical wall of the container proper 1a of the toner supply container 1a, and the semicylindrical wall of the toner supply container bay 10a. The developing device shutter 11 is engaged with a pair of guiding portions 10c attached to the bottom surface of the semicylindrical wall of the toner supply container bay 10a so that it is allowed to slide along the bottom surface of the semicylindrical wall of the toner supply container bay 10a to open or close the toner reception hole 10b.

When the toner supply container 1 is not in the toner supply container bay 10a, the developing device shutter 11 remains in the position in which one of its edges is in contact with the stopper 10d of the toner receiving apparatus 10, keeping the toner reception hole 10b sealed to prevent the contamination which occurs as toner flows back from the development chamber into the toner supply container bay 10a.

The toner receiving apparatus 10 is provided with a driving portion 12 as a driving force transmitting member, and a driving member cover 13 for protecting the driving force transmitting member 12, or the like purpose. The driving force transmitting member 12 and cover 13 are located at one end of the toner supply container bay 10a in terms of the lengthwise direction of the toner supply container bay 10a. The driving force transmitting member 12 is rotationally driven by the force from the main assembly of the image forming apparatus. The driving member cover 13 is configured and positioned so that the driving force transmitting member 12 appears completely covered as seen from the direction from which the toner supply container 1 is mounted (FIG. 7(c)).

The driving force transmitting member 12 is structured so that it is driven by the mechanical power source, which drives the toner moving member 201c and development sleeve 201b of the developing device, as well as the photosensitive drum 104; in other words, it is connected to the driving force transmission mechanism. Therefore, when the driving force transmitting member 12 is rotating, the development sleeve 210b is also rotating. Therefore, as the driving force transmitting member 12 is rotated in the direction opposite to the normal direction, the development sleeve 101b also is rotated in the direction opposite to the normal direction. Therefore, there is the possibility that this setup will create such a problem that the tips of the above described development blade 201d and/or toner leak prevention sheet 201e are tucked into their under sides.

According to the present invention, however, the problem that the development sleeve 201b is rotated in reverse by the reverse rotation of the driving force transmitting member 12 can be prevented, as will be described later, even if the toner receiving apparatus is structured as described above.

A distance L between the driving member cover 13 and the end of the toner supply container bay 10a opposite from the location of the driving member 13 is set to be no less than the length of the toner supply container 1, making it easy for the toner supply container 1 to be removably mounted into the toner supply container bay 10a. In other words, the toner receiving apparatus 10 is structured so that the toner supply container 1 can be mounted into, or dismounted from, the toner receiving apparatus 10 in the direction perpendicular to the lengthwise direction of the toner supply container 1 (direction in which coupling 5 is movable, that is, direction parallel to rotational axis of container proper 1a).

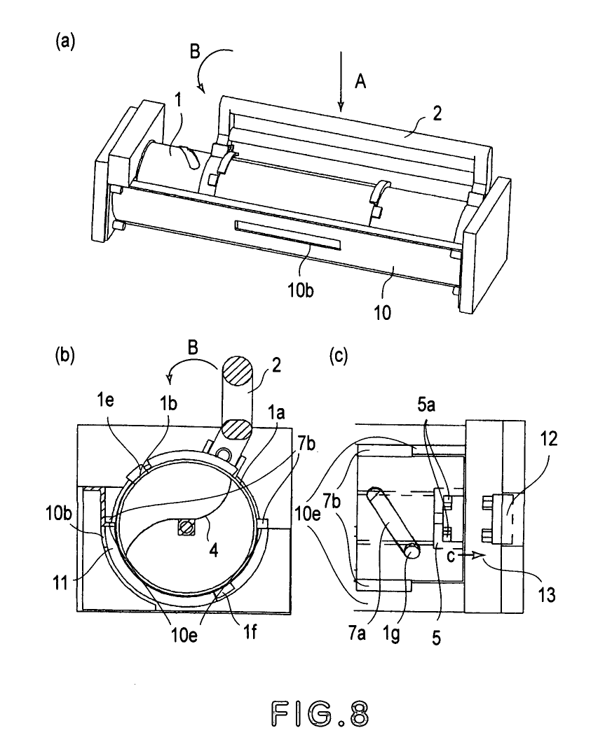

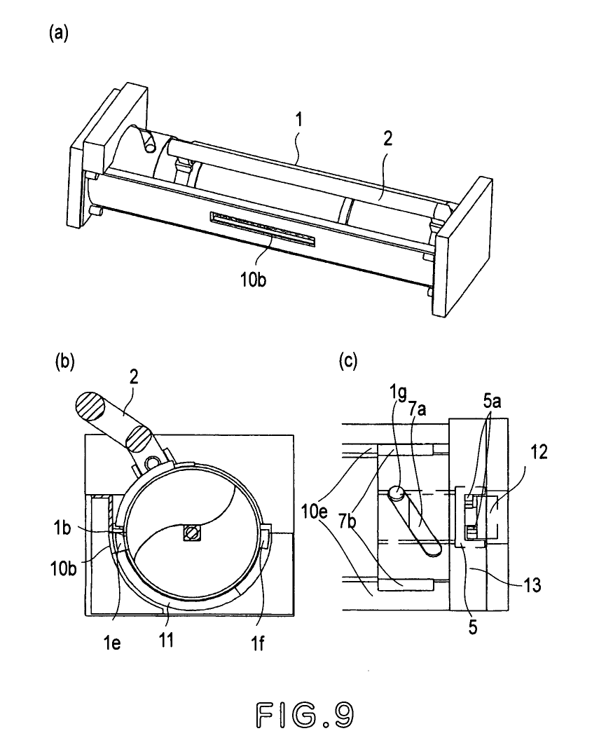

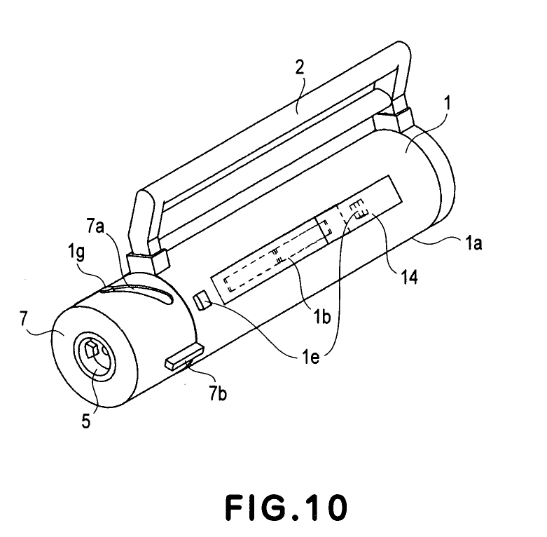

Next, referring to FIGS. 8(a)-(c), and FIGS. 9(a)-(c), the operation for supplying the main assembly of the image forming apparatus with toner with the use of the toner supply container 1 and toner receiving apparatus 10 in this embodiment will be described.

First, the toner supply container 1 is to be mounted into the toner receiving apparatus 10 in the direction indicated by an arrow mark A (FIG. 8(a)). As the toner supply container 10 is mounted, the two rotation control projections 7b of the coupling supporting portion 7 come into contact with the toner supply container rotation surfaces 10e, one for one, preventing thereby the coupling supporting portion 7 from rotating (FIGS. 8(b) and 8(c)).

Next, referring to FIGS. 8(a) and 8(b), a user is to rotate the toner supply container 1 in the direction indicated by an arrow mark B (frontward in FIG. 8) by the handle 2. As the toner supply container 1 is rotated, the developing device shutter 11 is pushed down by the pair of projections 1e of the toner supply container 1 by the rotation of the container proper 1a. As a result, the toner reception hole 10b is unsealed.

Also as the toner supply container 1 is rotated, the toner supply container shutter 3 is moved relative to the container proper 1a, because the container shutter 3 is prevented by the stopper portion of the toner receiving apparatus 10 from rotating with the container proper 1a. As a result, the toner discharge hole 1b is unsealed. Consequently, the toner discharge hole 1b becomes connected to the toner reception hole 10b (FIG. 8(b) FIG. 9(b)). The toner supply container 1 and toner receiving apparatus 10 are structured so that as the toner supply hole 1b becomes fully connected with the toner reception hole 10b, it becomes impossible for the container proper 1a to be rotated any further. More specifically, the developing device shutter 11 attached to the container proper 1a is prevented by the stopper portion of the toner receiving apparatus 10, from moving further, preventing thereby the container proper 1a from rotating further.

During the period in which the toner reception hole 10b and toner discharge hole 1b are being unsealed while being connected, that is, as the container proper 1a is rotated, the cam follower 1g is pushed by the wall of the camming hole 7a of the coupling supporting portion 7 in the direction to be moved along the camming hole 7a. However, the coupling supporting portion 7 is prevented, by the pair of rotation control projections 7b having come into contact with the toner receiving apparatus 7, from moving in the rotational direction of the coupling supporting member 7. Therefore, the force applied to the cam follower 1g by the coupling supporting member 7 is converted by the camming mechanism into the force which acts in the direction parallel to the axial direction of the container proper 1a.

Therefore, the coupling supporting member 7 is slid in the direction indicated by an arrow mark C in FIG. 8(c), causing the coupling 5 to be moved toward the driving force transmitting member 12 of the toner receiving apparatus 10. As a result, the coupling 5 couples with the driving force transmitting member 12, making it possible for the toner supply container 1 to receive the driving force from the main assembly (FIG. 8(c) FIG. 9(c)). As the coupling supporting portion 7 is slid in the arrow C direction (as coupling 5 couples driving force transmitting member 12), the toner supply container 1 increases in apparent length.

Through the above described steps, it becomes possible for the driving force from the toner receiving apparatus 10 to be transmitted to the stirring member 4 through the coupling 5 and intermediary member 6, making it possible to supply the main assembly with toner.

After the completion of the toner supplying operation, the user is to rotated the toner supply container 1 in the direction opposite to the direction indicated by the arrow mark B in FIG. 8, by grasping the handle 2. As the toner supply container 1 is rotated in the opposite direction, not only is the developing device shutter 11 pulled up by the pair of projections 1f of the toner supply container 1, sealing the toner reception hole 10b, but also, the toner discharge hole 1b is sealed by the toner supply container shutter 3, the rotational movement of which is regulated by the toner receiving apparatus 10 (FIG. 9(b)-8(b)).

Further, during the operational period in which the toner reception hole 10b and toner discharge hole 1b are resealed, the coupling supporting portion 7 is slid in the direction opposite to the arrow B direction, causing the coupling 5 to uncouple from the driving force transmitting member 12 (FIGS. 9(c) 8(c), as the container proper 1a is rotated in reverse.

Then, the container proper 1a is to be rotated into the position, from which the toner supply container 1 can be dismounted, or into which the toner supply container 1 is mounted; in other words, the container proper 1a is restored to the state in which it was immediately after it was mounted into the toner receiving apparatus 10. Lastly, the user is to pull the toner supply container 1 from the toner receiving apparatus 10 to end the toner supplying sequence.

With the provision of the above described mechanical arrangement, that is, by structuring the toner supply container 1 and toner receiving apparatus 10 so that as the container proper 1a is rotated, not only is the toner discharge hole 1b aligned with the toner reception hole 10b while being unsealed along with the toner reception hole 10b, by the rotation of the container proper 1b, but also, the coupling 5 is moved into the location at which it couples with the driving force transmitting member 12, it is possible to improve an image forming apparatus in terms of operational efficiency, without making the apparatus structurally complicated.

In other words, two separate operations can be accomplished by a single action of a user, making it possible to eliminate the time and labor necessary for the user to individually carry out two separate operations. Therefore, the apparatus can improved in operational efficiency.

Further, in the case of the structural arrangement in accordance with the prior art, during the period in which the toner discharge hole 1b is aligned with the toner reception hole 10b by the rotation of the container proper, the driving force transmitting member 12 is rotated in the direction opposite to the normal rotational direction. This problem can be prevented by this embodiment of the present invention. In other words, it is possible to prevent such problems that toner is unsatisfactorily conveyed, that the toner bearing member is unsatisfactorily coated with toner, and also, that toner leaks because the toner leak prevention sheet placed between the toner bearing member and the housing of the developing apparatus to seal the gap between them is bent and tucked into its under side.

On the other hand, by providing a locking mechanism for preventing the driving force transmitting member 12 from being rotated by the rotation of the container proper unless the toner supply container has been unsealed, it is possible to prevent the problematic phenomenon that occurs in a toner supply container structured in accordance with the prior art, that is, the phenomenon that because the stirring member in an unsealed toner supply container is rotated, coarse toner particles are formed in the toner supply container.

Further, in this embodiment, before the toner supply container is mounted into the toner receiving apparatus, the coupling 5 remains retracted in the toner supply container, that is, it is not projecting from the toner supply container. Therefore, even if the toner supply container is accidentally dropped during the shipment, or while being handled by an operator, the coupling 5 is not damaged.

Embodiment 2

Next, the toner supply container 1 as a developer supply container in the second embodiment of the present invention will be described.

The container in this embodiment is very similar in basic structure to the container in the above described first embodiment. Therefore, it will not be described here in order to avoid the repetition of the same description, and only its structural features different from those in the first embodiment will be described. The components, members, etc., of this container, which are identical in function as those of the container in the first embodiment will be given the same referential symbols as those given in the first embodiment.

Referring to FIG. 10, the toner supply container 1 in this embodiment is not provided with a container shutter such as the one in the first embodiment. Instead, its toner discharge hole 1b is sealed with a seal 14 formed of resin film.

In this embodiment, the seal 14 is to be peeled by an operator after the toner supply container 1 is mounted into the toner receiving apparatus 10, with the toner discharge hole 1b facing upward.

Thereafter, the container proper 1a of the toner supply container 1 is to be rotationally moved by grasping the handle 2, as was in the first embodiment, so that the developing device shutter is pushed down in the curvature direction of the container proper 1a of the toner supply container 1 to unseal the toner reception hole 10b. The procedure for resealing the toner reception hole 10b is the same as the one in the first embodiment, and therefore, will not be described here.

The same effects as those accomplished by the first embodiment can also be accomplished by this embodiment. However, in consideration of the contamination, or the like, which occurs after the completion of the toner supplying procedure, the first embodiment is preferable, because in the first embodiment, the toner discharge hole 1b is resealed by the container shutter 3.

Not only is the present invention is applicable to a developer supply container structured so that it can be removably mountable in an image forming apparatus (developer receiving apparatus) to supply the main assembly of the image forming apparatus with developer, but also, to another type of developer supply container, for example, a developer supply container structured so that it can be removably mountable in a process cartridge (which is removably mountable in main assembly of image forming apparatus, and is equivalent to developer receiving apparatus) in the main assembly of an image forming apparatus to supply the process cartridge with developer.

Here, a process cartridge means a cartridge in which the electrophotographic photosensitive member 104 as an image bearing member, and at least one image forming device among the charging device 203, developing device 201a, and cleaner 202, which act on the photosensitive member 104, which were mentioned in the above description of the preferred embodiments of the present invention, are integrally placed.

Further, in stead of the combination of the coupling and driving member, as a driving force transmitting means, in the above described first and second embodiments, a driving force transmitting means made up of a combination of gears may be employed. More specifically, in the case that a combination of gears is employed, gears will be employed as the actual driving force transmitting portion of the driving mechanism on the developer receiving side, and the actual driving force receiving portion on the developer supply container side. Also in such a case, the teeth of the gears are desired to be tapered so that the gear on the driving force transmitting side and the gear on the driving force receiving side will smoothly mesh with each other.

While the invention has been described with reference to the structures disclosed in the first and second embodiments of the present invention, it is not confined to the details set forth, and this application is intended to cover such modifications or changes as may come within the purposes of the improvements or the scope of the following claims.

This application claims priority from Japanese Patent Applications Nos. 411339/2003 and 341604/2004 filed Dec. 10, 2003 and Nov. 26, 2004, which is hereby incorporated by reference.

1. A developer supply container detachably mountable to developer receiving apparatus, comprising:
container body accommodating a developer, said container body being provided with a developer supply port for supplying the developer through a developer receiving port provided in the developer receiving apparatus;
a driving connecting member for operatively collectable with a driving member provided in the developer receiving apparatus, said driving connecting member being movable relative to said container body;
an interrelating mechanism for interrelating an operation of movement of said driving connecting member to operatively couple with said driving member with an operation of movement of said developer supply port to face the developer receiving port.

2. A developer supply container according to claim 1, wherein said interrelating mechanism moves said driving connecting member toward said driving mechanism, utilizing a rotation of said container body after said developer supply container is mounted to the developer receiving apparatus.

3. A developer supply container according to claim 2, further comprising a grip portion for rotating said container body.

4. A developer supply container according to claim 2 or 3, wherein said interrelating mechanism includes a cam mechanism for advancing and retracting said driving connecting member in a direction of a rotational axis by a rotation of said container body.

5. A developer supply container according to claim 4, wherein said interrelating mechanism interrelates an operation of movement of said driving connecting member to a position where said driving connecting member is retracted from said driving member with an operation of movement to a position for permitting removal of said developer supply container, where said developer supply port does not face said developer receiving port.

6. A developer supply container according to claim 1, wherein a moving direction of said developer supply port is different from a moving direction of said driving connecting member.

7. A developer supply container according to claim 1, wherein a mounting and demounting direction of said developer supply container relative to said developer receiving apparatus is crossing with an advancing and retracting movements of said driving connecting member.

8. A developer supply container according to claim 1, further comprising a stirring member for stirring the developer in said container body, wherein said driving connecting member transmits a driving force received from said driving member to said stirring member.

9. A developer supply container according to claim 1, further comprising a container shutter for opening and closing said developer supply port, wherein said container shutter unseals said developer supply port with the operation of movement of said developer supply port to a position facing said developer receiving port, and said container shutter reseals said developer supply port with integration of movement of said developer supply port to a position for mounting and demounting of said developer supply container.

10. A developer supply container according to claim 1, wherein said driving connecting member is retractable inwardly of an outer surface of said developer supply container.

11. A developer supply container according to claim 1, further comprising an engaging portion provided on said container body and engageable with an apparatus shutter, of said developer receiving apparatus, for opening and closing said developer receiving port.

12. A developer supply container detachably mountable to a developer receiving apparatus, said developer receiving apparatus including a developer receiving port and an apparatus shutter for opening and closing the developer receiving port, said developer supply container comprising:
container body accommodating a developer, said container body being provided with a developer supply port for supplying the developer through a developer receiving port provided in the developer receiving apparatus;
a driving connecting member for operatively collectable with a driving member provided in the developer receiving apparatus, said driving connecting member being movable relative to said container body;
an engaging portion engageable with said apparatus shutter provided in said container body;
a grip portion for rotating said container body to open and close said apparatus shutter by said engaging portion;
an interrelating mechanism for interrelating an advancing and retracting movement of said driving connecting member relative to said driving member with opening and closing operations of said apparatus shutter.

13. A developer supply container according to claim 12, wherein said interrelating mechanism interrelates an operation of movement said driving connecting member to a position for operative connection with an unsealing operation of said apparatus shutter, and interrelates an operation of movement of said driving connecting member to a position retracted from said driving member with a resealing operation of said apparatus shutter.

14. A developer supply container according to claim 13, wherein said interrelating mechanism includes a cam mechanism for advancing and retracting said driving connecting member in a direction of a rotational axis by a rotation of said container body.

15. A developer supply container according to claim 12, wherein said driving connecting member is movable in a direction of a rotational axis of said container body.

16. A developer supply container according to claim 12, wherein a mounting and demounting direction of said developer supply container relative to said developer receiving apparatus is crossing with an advancing and retracting movements of said driving connecting member.

17. A developer supply container according to claim 12, further comprising a stirring member for stirring the developer in said container body, wherein said driving connecting member transmits a driving force received from said driving member to said stirring member.

18. A developer supply container according to claim 12, further comprising a container shutter for opening and closing said developer supply port, wherein when said container body is rotated, opening and closing operations of said container shutter is interrelated with opening and closing operations of said apparatus shutter.

19. A developer supply container according to claim 12, wherein said driving connecting member is retractable inwardly of an outer surface of said developer supply container.
